(19) United States
(12) Patent Application Publication
(10) Pub. No.: US 2011/0288283 A1
(43) Pub. Date: Nov. 24, 2011

(54) PROCESS FOR PRODUCING GLYCOSAMINOGLYCANS

(75) Inventor: Ragnar Flengsrud, As (NO)

(73) Assignee: HEPMARIN AS, As (NO)

(21) Appl. No.: 13/002,765

(22) PCT Filed: Jul. 15, 2009
(86) PCT No.: PCT/GB2009/001784

§ 371 Date: Apr. 4, 2011

(30) Foreign Application Priority Data
Jul. 15, 2008 (NO) 0812919.9

(51) Int. Cl. C08B 37/10; C08B 37/00

(52) U.S. Cl. 536/21; 536/55.1

(57) ABSTRACT

The invention provides a process for the production of a composition comprising a glycosaminoglycan, said process comprising subjecting a homogenate of glycosaminoglycan-containing animal material to chromatography using a chromatographic matrix in the form of a membrane adsorber.

The present invention relates to processes for the production of glycosaminoglycan (GAG) compositions, preferably compositions comprising anticoagulant GAGs such as heparins. Especially preferably, the glycosaminoglycans are extracted from non-mammalian marine animals, such as fish or krill.

Glycosaminoglycans consist of two sub-groups namely, galactosaminoglycans and glucosaminoglycans. Heparin is the name given to a class of sulphated glucosaminoglycans having anticoagulant properties. Besides heparin, other anticoagulant sulphated glucosaminoglycans (often referred to as heparinoids) are known, e.g. heparan sulphate. These too have been used to achieve anti-coagulant or anti-opsonization effects. However, heparin is the most commercially significant of the group.

The anticoagulant glycosaminoglycans are polysaccharides with repeating sulphated disaccharide units. The polysaccharide structure may additionally contain other oligosaccharide substructures, e.g. the pentasaccharide unit known to bind to antithrombin. Thus, besides its trisuiphated disaccharide repeat unit, heparin contains additional saccharide units, e.g. disulphated disaccharides, and some heparin contains the pentasaccharide which is a high affinity binding site for antithrombin. Heparin containing this pentasaccharide binding site for antithrombin is known as high affinity heparin.

The different glycosaminoglycans differ in the inter-saccharide bonds and the saccharide ring substitution. Moreover, for a particular animal species, the chain length varies and thus the glycosaminoglycans have molecular weight distributions rather than specific molecular weights, i.e. they are polydisperse.

Heparin has a polymeric structure and thus heparin compositions generally contain heparins having a range of molecular weights, typically from 3 kDa to 40 kDA. Heparin with this wide range of molecular weights is usually referred to as unfractionated heparin (UFH). As currently used commercially, UFH typically has molecular weights in the range 5.0 to 40 kDa.

In recent years there has been significant interest in the production and use of low molecular weight heparin (LMWH), i.e. a material containing heparin, but of low molecular weight, typically less than 8 kDa, especially heparins in which at least 60 mol % have a molecular weight below 8 kDa. LMWH has a potency of at least 70 units/mg of anti-factor Xa activity and a ratio of anti-factor Xa activity to anti-factor IIa activity of at least 1.5.

LMWH can be produced from native unfractionated heparin by a variety of processes, e.g. by fractionation or depolymerisation by chemical or enzymatic cleavage, e.g. by nitrous acid depolymerisation, oxidative depolymerisation with hydrogen peroxide, deaminative cleavage with isoamyl nitrite, alkaline beta-eliminative cleavage of the benzyl ester of heparin, oxidative depolymerisation with Cu²⁺ and hydrogen peroxide or by heparinase digestion.

There has also been increased interest in synthetic production of very low molecular weight heparin (VLMWH). We have previously shown that heparin extracted from marine animals, in particular fish, naturally has a high content of LMWH and surprisingly also of very low molecular weight heparin (VLMWH), i.e. heparin having a molecular weight less than 3 kDa (see WO 2006/120425, the contents of which are hereby incorporated by reference).

There is a growing concern about the use of GAGs from mammalian sources in view of the perceived potential for cross-species viral and prion infection. Marine GAGs (e.g. heparin extracted from marine animals) thus provides an alternative. The extraction of marine heparin is described in WO 02/076475, the contents of which are hereby incorporated by reference.

Previous methods for extracting GAGs from marine material include ion exchange chromatography, electrophoretic separation, sequential precipitation in various organic solvents and various other methods, including those described in the prior art for extraction from animal sources. Many of these techniques are time consuming and inefficient, thus there exists a need for alternative processes for the production of GAGs of marine origin. For example, AT-Sepharose chromatography purifies only the high affinity parts of heparin, whereas, the Applicant has found, conventional bead-based ion exchange systems may also bind unwanted compounds such as lipids. Moreover, in these known techniques, washing must be performed for an extended period of time and high volumes of buffer solutions are required in order to elute the GAGs from the columns (this makes further processing laborious). This leads to problems such as oxidation, precipitation and lack of activity.

The Applicant has further identified that existing methods for extraction of GAGs from marine animal material may suffer from problems such as unfeasibly long processing times (i.e. up to several days, which can result in release of the odour of decaying fish waste) and low total activity of the resulting product.

Therefore, in view of the above-mentioned advantages of marine heparins, but the problems associated with current extraction methods, there exists a need for alternative processes for the production of GAGs of marine origin. We have surprisingly found that chromatography using a chromatographic matrix, for example, using a membrane adsorber, particularly an anion exchange membrane adsorber, in extraction of GAGs from non-mammalian marine animal material provides a convenient alternative to conventional extraction techniques. The technique is easy to scale up and automate and it has been surprisingly found that products with outstanding purity and high activity can be produced simply and efficiently.

Thus viewed from one aspect the invention provides a process for the production of a glycosaminoglycan composition, said process comprising subjecting a homogenate of glycosaminoglycan-containing non-mammalian marine animal material to chromatography using a chromatographic matrix, preferably in the form of a membrane adsorber.

Viewed for a further aspect, the invention provides a process for extracting glycosaminoglycans from glycosaminoglycan-containing non-mammalian marine animal material said method comprising homogenising said animal material and subjecting the homogenate to chromatography using a chromatographic matrix, preferably in the form of a membrane adsorber.

In a preferred aspect, the homogenate is repeatedly applied to the chromatographic matrix.

Preferably, the chromatographic matrix is a membrane adsorber. Membrane adsorbers offer an alternative to traditional bead-based chromatography columns. They are typically based on a chemically stable cellulosic membrane to which a variety of chromatography ligands can be covalently bound. The membrane typically achieves separation by reversible binding of the target molecules to the ligand via their functional groups in a manner analogous to ion exchange chromatography. Typical ligands types are strong/weak anion or cation exchange ligands, metal chelates, epoxy and aldehyde ligands.

Cationic exchange membranes comprise ligands which contain anionic function groups such as —SO₃⁻, —OPO₃⁻ and —COO⁻, e.g. carboxymethyl (CM), sulphopropoyl (SP) and methyl sulphonate (S). Anionic exchange membranes typically contain ligands with cationic functional groups such as —NHR₂⁺ and —NR₃⁺, e.g. diethylaminoethyl (DEAE), quaternary aminoethyl (QAE) and quaternary ammonium (Q). Quaternary ammonium (Q) is particularly preferred for use in the present invention.

Membrane adsorbers are macroporous and their major kinetic effect is believed to be convective flow and rapid film diffusion. The adsorbers allow large flow rate ranges without the diffusion limitations found with conventional chromatographic bead/resins etc.

Membrane adsorbers can be used in a variety of chromatographic applications. Current uses are for the removal of DNA, viruses and endotoxins from pharmaceutical proteins and the purification of viruses, proteins and peptides from solutions. The advantages achieved by the application of this technique to polysaccharides have not previously been appreciated.

Single use, disposable membrane adsorbers are available, as are membranes which can be reused after suitable treatment. Suitable systems for use in the process of the invention are the Sartobind Membrane Adsorbers available from Sartorius (e.g. Sartobind Anion Direct). The use of a membrane adsorber according to the invention removes the requirement for costly and time consuming column packing and cleaning validation associated with bead-based chromatography systems. It also allows the required number and volume of buffers to be minimised. Use of membrane adsorbers in chromatography allows the process time and buffer usage to be reduced. The adsorbers allow large flow rate ranges and have high binding capacities. Their open structures allows a wide-range of volumes, flow-rates etc. to be used and provide a large surface area for sample/ligand interaction.

The process of the invention may be a batch process or a column process. The variety of bed-volumes allows the technique to be highly flexible and easy to scale-up. The high volume throughput obtainable with membrane adsorbers makes the process of the invention highly productive compared with conventional methods.

Preferably the homogenate is extracted from the waste from animal material, e.g. a non-mammalian marine animal after removal of muscle tissue, e.g. for use as a human foodstuff.

By non-mammalian marine animal material is included material derived from fresh-water as well as salt-water fish, shellfish and crustaceans, such as krill.

Non-mammalian marine animals used as food sources for mammals or as raw materials for fish meal, fish food, and fish oil are preferred. Particularly preferably, farmed non-mammalian marine animals are used.

Examples of suitable non-mammalian marine animals include: prawns, shrimp, krill, carp, barbell and other cyprinids; cod, hake, haddock; flounder; halibut; sole; herring; sardine; anchovy; jack; mullet; saury; mackerel; snoek; cutlass fish; red fish; bass; eels (e.g. river eels, conger, etc.); paddle fish; tilapia and other cichlids; tuna; bonito; bill fishes; diadromous fish; etc. Particular examples of suitable fish include: flounder, halibut, sole, cod, hake, haddock, bass, jack, mullet, saury, herring, sardine, anchovy, tuna, bonito, bill fish, mackerel, snoek, shark, ray, capelin, sprat, brisling, bream, ling, wolf fish, salmon, trout, coho and chinock. Especially preferably the non-mammalian marine animal used is trout, salmon, cod or herring, more especially salmon or hill. Krill are particularly preferred, for example Antarctic hill (Euphausia superba), Pacific krill (Euphausia pacifica) and Northern krill (Meganyctiphanes norvegica).

The glycosaminoglycan-containing non-mammalian marine animal waste used as the source for heparin extraction will typically be selected from heads, skin, gills, and internal organs. The use of gills alone, of heads and of internal organs is especially preferred. Methods of processing fish waste are known from the literature, e.g. WO2004/049818.

The homogenate of the animal material can be prepared by standard methods, e.g. physical or chemical pretreatment, e.g. maceration, acid or base treatment, etc., in particular grinding or blending.

The homogenate may be further treated in order to remove particulate material, for example via centrifugation and/or filtration. However, this is not always necessary, for example we have surprisingly found that crude homogenate can be applied directly to the membrane (conventional chromatography generally requires more extensive pre-treatment steps). However, in the process of the invention, the homogenates are preferably centrifuged or otherwise subjected to fines-removal, particularly if the source is fish gill material.

In an especially preferred embodiment, the homogenate is treated with an enzyme, particularly a protease such as papain in order to digest the proteins present in the homogenate, prior to application to the membrane system. Alternatively, or additionally, the homogenate may be heated to 50 to 200° C., preferably 70 to 120° C., especially preferably, 80 to 100° C., e.g. around 80° C. in order to inactivate the proteins.

Typically, the pH of the sample should be adjusted such that it is at least 1.0 above or below the isoelectric point of the desired GAG (for anion- or cation-exchange respectively). Anion exchange is preferred for the GAG extraction of the present invention, in which case a pH of around 5 is preferred.

The pH of the membrane may be stabilized prior to sample application, for example by using an equilibrium buffer. Equilibrium buffers (and other conditions and methods) used in standard chromatographic separation techniques may be used in the process of the invention. For example, for anion exchange, suitable buffers (which may include a salt, such as NaCl) are NH₄Ac/HAc, Bis-Tris/HCl and citrate buffer, e.g. 5 mM NH₄Ac/HAc, 10 mM NaCl/25 mM NH₄Ac/HAc, 10 mM NaCl/25 mM Bis-Tris/HCl and 10 mM NaCl/25 mM citrate buffer. Suitable equilibration buffers for use in the invention when a cation exchange membrane is utilised are; citrate, formate, acetate, malonate, MES, phosphate etc.

For anion exchange, the pH of the equilibrium buffer will be 4.5 to 10, preferably 5 to 6.5, e.g. around 5.5. For cation exchange, much lower pHs are required, e.g. 1 to 4, preferably around 2.

The method of the present invention enables the sample (homogenate) to be recirculated, and thus the exposure of the sample to the matrix can be controlled. Said recirculation can be achieved in any convenient manner, for example by positioning the inlet and outlet tubings in the same vessel. The homogenate can therefore be repeatedly applied to the chromatographic matrix. Preferably the homogenate is repeatedly applied to the matrix (e.g. the membrane adsorber) by recirculating the homogenate. That is, the flow-through (i.e. any material not bound to the matrix) is reapplied to the matrix, preferably immediately following it leaving the membrane adsorber (i.e. before elution of eluate). Especially preferably the homogenate is recirculated, i.e. repeatedly applied to the matrix for several minutes (e.g. up to 4 hours) before the bound compounds are eluted. Typical application times are 5 minutes to 3 hours, preferably 15 minutes to 2 hours, more preferably 30 minutes to 1.5 hours, especially preferably 45 minutes to 1 hour. A typical residence time for a 2.5 ml membrane in recirculation mode for 30 minutes is around 2.8 s.

Thus, viewed from a further aspect, the present invention provides a process for the production of a glycosaminoglycan composition, said process comprising subjecting a homogenate of glycosaminoglycan-containing non-mammalian marine animal material to chromatography using a chromatographic matrix, wherein said homogenate is repeatedly applied to said matrix. In this embodiment, the matrix is preferably in the form of a membrane adsorber as herein described.

After the sample has been applied to the membrane, whether by a single pass or by using recirculation as described above, the bound GAG compounds can be eluted. Elution may be effected using step-wise increases in ionic strength and/or changes in pH, or a suitable gradient. Preferably, elution is carried out using a suitable elution buffer. Clearly these will depend on the nature of the stationary phase. For anion exchange, the pH of the elution buffer will be 4.5 to 10, preferably 5 to 6.5, e.g. around 5.5.

Suitable elution buffers for use in anion exchange methods according to the invention are those in which the concentration of the mobile phase counter ion is increased. This is conveniently effected by adding NaCl to the equilibrium buffer. 1-15M, preferably 2-20M, e.g. 3-4M NaCl is typically used for anion exchange methods e.g. buffers such as 1-4 M NaCl in 5 mM NH₄Ac/HAc, 3 M NaCl in 25 mM NH₄Ac/HAc, 10 mM NaCl in 25 mM citrate buffer, 3.5 M NaCl/5 mM citrate buffer. Suitable elution buffers for use in the invention when a cation exchange membrane is utilised are; citrate, formate, acetate, malonate, MES, phosphate. In both cases the pHs are similar to those outlined for the equilibrium buffers above.

The GAG-containing composition of the process may be concentrated, desalted and/or dried before further handing. Freeze drying is preferred. In a preferred embodiment, the eluate is desalted, e.g. using a Millipore/Amicon stirred cell with a Nanomax-50 filter, and then freeze-dried. This is particularly useful if the unfractionated product (UFH) is to be fractionated as it removes the salt and minimizes the volume of the redissolved sample to be applied to a size exclusion chromatography (SEC) column, e.g. a G-75 Sephadex column.

The membrane can be reused after elution, by washing in a suitable buffer solution such that the membrane is regenerated.

Moreover, the flow-through (i.e. the material which has been applied to the membrane, whether by a single application or using recirculation, but did not bind) can be reapplied to the membrane after the elution step. In this way, the same homogenate can be used until all substantially of the desired GAG has been isolated.

In a further aspect of the invention, more than one membrane adsorber can be used, these can be arranged in series or parallel.

Membrane capacities can be chosen according to the size of the sample, and thus the method is easy to scale up. Typical bed volumes are in the range of from 5 to 2500 ml, whereas membrane areas are typically from 200 cm³ to 10 m³.

The invention allows use of higher flow rates than conventional ion chromatography. These will depend on the capacity of the membrane. Typical flow rates for a 2.5 ml membrane are, 5 to 60 ml/min, especially 10 to 50 ml, especially preferably 20 to 40 ml/min, for example around 30 ml/min.

Recirculation time and flow rate can be adjusted according to requirements. The total amount of sample exposed to the matrix is the product of recirculation time and flow rate.

The degree of exposure of the sample to the membrane is defined as (recirculation time×flow rate)/matrix volume. For example, recirculating at 25 ml/min for 1 hour, results in a volume of 1500 ml being exposed to the matrix (60 min×25 ml/min). For a 2.5 ml membrane, this equates to a degree of exposure value of 600 (i.e. 600 ml per ml of membrane). Preferably, the degree of exposure as defined herein is from 50 to 3000, preferably 200 to 1000, especially 400 to 800, more especially 500 to 700, particularly around 600.

At any stage in the process of the invention, antioxidants may be used in order to avoid any unwanted decomposition.

Typical membrane binding capacities (cm³) are >0.8 mg BSA on strong anion, >0.8 mg lysozyme on strong cation.

Typical static binding capacities (mg/device volume) are >72 mg/2.5 ml, >720 mg/25 ml, >7200 mg/250 ml;

The ion capacity (cm³) is usually around 4-6μ equiv.

Preferably the feed stream is routed tangentially over the membrane layers which are separated by a spacer.

The glycosaminoglycan (GAG) extracted by the process of the invention are preferably glucosaminoglycans, especially those with anticoagulant properties, particularly heparin, a heparinoid, or a low molecular weight heparin or heparinoid, or a mixture of two or more thereof. Preferably it is a sulphated GAG, in particular a heparin or LMWH, especially preferably it is a high affinity GAG.

By “anticoagulant” it is meant that a GAG has the ability to bind to antithrombin, an inter-alpha-trypsin inhibitor, factor Xa, and other proteins to which mammalian heparin binds, e.g. immobilized on a substrate such as a gel matrix, and/or the ability to delay or prevent clotting in human plasma or to prolong bleeding in a mammal (e.g. a mouse).

Glycosaminoglycans, particularly anticoagulant glycosaminoglycan or glucosaminoglycans, especially preferably heparins extracted from krill, are in themselves novel and inventive and thus form a further aspect of the present invention. Preferably these glycosaminoglycans are extracted via the processes described herein, however any suitable extraction method may be used, for example those set out in WO 02/076475 and WO 2006/120425.

Both the krill GAG products mentioned above and the products of the process of the invention constitute a further aspect of the invention. These products may be further processed, for example the resulting UFH compositions may be treated (e.g. fractionated or depolymerized) to give compositions enriched or depleted in LMWH and/or VLMWH etc. The fractions, and compositions enriched or depleted in them, form a further aspect of the present invention.

The products of the invention may be used according to the invention in its naturally occurring form following extraction, for example as UFH. However alternatively it may be converted into salt form, preferably with a physiologically tolerable counterion (e.g. sodium, calcium, magnesium, potassium, ammonium or meglumine), or derivatised, e.g. to facilitate its binding to a surface of an item of medical apparatus, or molecular weight fractionated or depolymerised (e.g. to produce a GAG fraction meeting the molecular weight definition for LMWH). As with the products of the processes herein described, such derivatives are preferably physiologically tolerable.

Preferably, the product of the chromatographic process is then fractionated and/or depolymerised.

Preferably, fractionation is achieved by filtration (e.g. membrane filtration) or chromatographically, especially preferably using size exclusion chromatography, ion exchange chromatography, or sample displacement chromatography. Suitable methods are set out in WO 2006/120425.

In a preferred embodiment of the invention the marine GAG composition is concentrated and desalted before further processing such as fractionation.

Especially preferably the marine GAGs of the invention are subjected to membrane filtration to remove low molecular weight components, e.g. with a molecular weight before that of the antithrombin binding pentamer (MW 1728 Da), typically using a membrane with a 1 kDa cut-off (e.g. Omega-1k Ultrasette from Filtron/Pall, Millipore Pellicon 1 kDa cut-off). Also especially preferably the marine GAGs are subjected to membrane filtration to remove high molecular weight components, for example with a molecular weight cut-off of 3000 Da (e.g. using Omega Centramate Suspended Screen OS005C11P1 from Filtron/Pall). This enables the production of LMWH- and/or VLMWH-enriched fractions in addition to the UFH product. Such fractions can be used separately, in combination (e.g. in combination therapy) or blended to provide GAG compositions to meet a variety of requirements. For example, the product may be fractionated to produce a fraction enriched in LWMH or VLMWH. The remaining fraction, depleted in either LMWH or VLMWH, may be retained and used alone or added to further unfractionated product. In this way waste of the products is minimised.

The compositions produced according to the process of the invention and described herein (whether UFH or following the fractionation steps set out above) may be dried or may be formulated for use, e.g. with a diluent, carrier or an active drug substance, and it may be applied, preferably after formulation with a liquid carrier, as a coating to the surface of a medical instrument, e.g. a catheter or implant. Such compositions and coated instruments form further aspects of the present invention, as does the process for their preparation, e.g. by admixing or coating.

Viewed from a further aspect the invention provides a non-mammalian marine animal glycosaminoglycan composition produced by the processes herein described, optionally further containing a physiologically acceptable carrier or excipient and/or a drug substance and optionally coated onto a substrate. Such compositions for use in medicine or therapy form a further aspect of the present invention.

Viewed from a further aspect the invention provides a hill glycosaminoglycan composition, optionally further containing a physiologically acceptable carrier or excipient and/or a drug substance and optionally coated onto a substrate. Such compositions for use in medicine or therapy form a further aspect of the present invention.

Viewed from a still further aspect the invention provides the use of a composition according to the invention or produced according to the process of the invention, or a salt or derivative thereof, in mammalian, especially human, medical treatment, e.g. in compositions or equipment used in surgery, therapy, prophylaxis, or diagnosis on human or non-human animal subjects or for blood contact. In a preferred aspect, the compositions are fractionated (e.g. according to activity or molecular weight) to provide compositions enriched in certain fractions, e.g. VLMWH.

Viewed from a further aspect the invention provides a pharmaceutical composition comprising hill GAGs or non-mammalian marine animal GAGs produced by the process herein described or a salt or derivative thereof together with a physiologically tolerable carrier or excipient, and optionally also a therapeutic or prophylactic drug substance.

The GAG compositions according to the invention may further contain non-GAG components conventional in mammalian GAG compositions, e.g. water (preferably water for injections), ethanol, buffers, osmolality adjusting agents, preservatives, etc.

Besides use as anticoagulants, the GAGs of the invention may be used as antithrombotics, anti-atherosclerotics, complement inhibitors, anti-inflammatories, anti-cancer agents, anti-viral agents, anti-dementia agents (e.g. anti-Alzheimer agents), anti-prion agents, anti-parasitics, opsonization inhibitors, biomaterials, angiogenesis regulators, and in the treatment of vascular deficit, wounds and immune response disorders (e.g. AIDS), etc. They may be administered enterally or parenterally, e.g. orally or subcutaneously or bound to an object or drug material placed into tissue or the circulatory system.

Besides such therapeutic and surgical uses, the GAGs of the invention may be used for diagnostic purposes, e.g. diagnostics assays, and non-medical uses for which heparin is suited or currently used. Thus viewed from a further aspect the invention provides a diagnostic assay kit comprising an anticoagulant, characterised in that said anticoagulant is a glycosaminoglycan according to the invention.

The process of the invention has been carried out on mammalian material and has been found to be equally applicable to mammalian material as it is to material of non-mammalian marine animal origin. The glycosaminoglycan-containing mammalian material used as the source for heparin production/extraction according to this aspect of the present invention is preferably waste from meat-processing, i.e. waste following the extraction of material for food. Intestines, preferably bovine or porcine intestines, are thus preferred sources. The above-mentioned processes, products and uses, using mammalian material (preferably non-human mammalian intestinal material) rather than non-mammalian marine animal material, thus form further aspects of the present invention.

Thus, viewed from a further aspect the present invention provides a process for the production of a glycosaminoglycan composition, said process comprising subjecting a homogenate of glycosaminoglycan-containing mammalian intestines to chromatography using a chromatographic matrix in the form of a membrane adsorber. A process for the production of a glycosaminoglycan composition, said process comprising subjecting a homogenate of glycosaminoglycan-containing mammalian intestines to chromatography using a chromatographic matrix (preferably a membrane adsorber) wherein said homogenate is repeatedly applied to said matrix is also provided.

Preferably the mammal from which the mammalian material is derived is a non-human mammal. Examples of suitable mammals include cattle, goats, sheep, deer, pigs, swine, boar etc. Bovine and porcine materials are especially preferred.

Documents referred to herein are hereby incorporated by reference.

The invention will now be described further with reference to the following non-limiting Examples. In all Examples the pump used was a Pump Masterflex I/P, except for elution where a peristaltic Pharmacia P-1 pump was used. The membrane used was a 2.5 ml Sartobind® Anion Direct, Strong basic anion exchanger membrane.

### EXAMPLE 1

### Salmon Intestine Extract

A salmon intestine extract was prepared by homogenizing 280 g salmon intestines in Milli-Q water. The theoretical amount of GAG (glycosaminoglycan) as measured by the carbazole method was calculated as 98 mg (N.B. the carbazole test results in a red/violet colour for glycosaminoglycans which contain uronic acid).

Proteins were degraded by papain at 55° C., then inactivated by heating to 80° C. Coarse particles were removed by filtering through a nylon filter. The extract was then adjusted to pH 5.5 by adding 0.5 M ammonium acetate/acetic acid (pH 5.5) to 25 mM (final concentration of acetate) and NaCl (final concentration of 10 mM). The pH was measured as 6.08.

Elution 1: The resulting extract was then recirculated (by immersing the inlet and outlet of the tubing in the same beaker) on a the membrane at around 25 ml/min for 64 minutes and then washed with 150-200 ml of the equilibration buffer (25 mM acetate/acetic acid/10 mM NaCl, pH 5.5). Elution was then carried out using 20 ml 3 M NaCl in 5 mM NH₄Ac/HAc, pH 5.5 (Eluate no. 1).

Elution 2: The membrane was then washed with equilibration buffer and the extract (i.e. the flow-through from Elution 1) was applied again, this time for 45 min. It was washed with equilibration buffer (150-200 ml) and allowed to stand overnight. Elution was then carried out using 20 ml 3 M NaCl in 5 mM NH₄Ac/HAc, pH 5.5 (Eluate no. 2).

Elution 3: The membrane allowed to stand in 1 M NaOH for around 1 hour and was then washed with equilibration buffer. The extract (i.e. the flow-through from Elution 2) was applied again for 55 min, washed with equilibration buffer, then eluted in 3 M NaCl in 5 mM NH₄Ac/HAc, pH 5.5 (Eluate No. 3).

Elution 4: The membrane allowed to stand with 1 M NaOH for around 1 hour and was then washed with equilibration buffer. The extract (i.e. the flow-through from Elution 3) was applied again for 51 min, washed with equilibration buffer, then eluted in 3 M NaCl in 5 mM NH₄Ac/HAc, pH 5.5 (Eluate No. 4).

Elution 5: The equilibration buffer was then changed to 25 mM NH₄Ac/HAc, pH 5.0/10 mM NaCl and pH in the extract (i.e. the flow-through from Elution 4) adjusted to 4.96 (using 6 M HCl). This was circulated on the membrane for 60 min, and the membrane was then washed with 200 ml of the equilibration buffer. Eluate no. 5 was obtained using 20 ml 3 M NaCl in 25 mM NH₄Ac/HAc, pH 5.0.

Elution 6: The pH of the extract (i.e. the flow-through from Elution 5) was then adjusted to 5.5 (using 3M NaOH), and the membrane was washed with in 25 mM NH₄Ac/HAc, pH 5.5/10 mM NaCl. The extract was recirculated on the membrane for 60 minutes. Eluate no. 6 was obtained using 3 M NaCl (20 ml) in 5 mM NH₄Ac/HAc, pH 5.5.

Elution 7: The membrane was kept in 20% EtOH in equilibration buffer overnight and then treated with 1 M NaOH for around 45 minutes, then washed. The extract (i.e. the flow-through from Elution 6) was recirculated for 60 minutes on the membrane. Eluate no. 7 was obtained using 3 M NaCl (20 ml) in 5 mM NH₄Ac/HAc, pH 5.5.

The results are summarised in the following table:

| | Eluate | Weight of | Concentration of | |
|---|---|---|---|---|
| | volume | heparin in | heparin in eluate | |
| Eluate | (ml) | eluate (mg) | (mg/ml) | Comments |
| 1 | 14.2 | 0.794 | 0.0559 | Carbazole test |
| | | | | gave a brownish |
| | | | | colour |
| 2 | 19.0 | 0.974 | 0.0513 | pH 6.06 in extract |
| 3 | 19.0 | 0.706 | 0.0372 | Yellow/brown in |
| | | | | test |
| 4 | 18.9 | 1.635 | 0.0171 | |
| 5 | 20.3 | 0.210 | 0.0103 | pH 5.0 in extract |
| 6 | 15.5 | 0.722 | 0.0460 | pH 5.5 in extract |
| 7 | 18.9 | 2.074 | 0.1097 | Yellow in test |
| Sum | | 7.12 | | |

The pooled eluates (i.e. Eluates 1 to 7 are combined) were concentrated and desalted for biological tests.

### EXAMPLE 2

### Salmon Intestine Extract, Part II

The salmon homogenate that had been passed 7 times on the membrane (i.e. the flow-through from Elution 7 of Example 1) was kept at +4° C. and pH was adjusted to 6.0 with Bis-Tris (i.e. Bis(2-hydroxyethyl)amino-Tris(Hydroxy-methyl)methane). The membrane was washed 3 times with 1 M NaOH (with buffer washings of 25 mM Bis-Tris/HCl/10 mM NaCl, pH 6.0 in-between) and then equilibrated with 25 mM Bis-Tris/HCl/10 mM NaCl, pH 6.0 (the equilibration buffer).

The homogenate was recirculated on the membrane at room temperature for 60 minutes at a flow rate of 25 ml/min. The in/out tubings were in the same beaker, as in Example 1, with the inlet at the bottom and the outlet on the top. After washing with the equilibration buffer, elution was carried out using 3 M NaCl in 5 mM NH₄Ac/HAc, pH 5.5 (as previously). The volume of the eluate was 24.4 ml.

The total amount of uronic acid-containing GAG as measured by the carbazole test was 0.933 mg.

### EXAMPLE 3

The combined eluates (1 to 7) from Example 1 were concentrated and desalted on a Millipore Pellicon 1000 MWCO membrane using tangential flow. The sample (i.e. everything from the eluates of Example 1 which has a molecular weight above 1000 Da) was then freeze-dried. The white, powder-like residue obtained had a weight of 630 mg.

An aliquot of freeze-dried eluate was tested for heparin activity in a thrombin/antithrombin assay using a colorimetric thrombin substrate. This test revealed a strong heparin activity. A further aliquot of the freeze-dried eluate was analysed for quantitative heparin activity determination. The 21.5 mg aliquot gave 0.26 U/ml (dissolved in 1 ml). This equals a total of 7.62 U in 630 mg.

### EXAMPLE 4

### Salmon Intestine Extract, Part III

The homogenate that had been passed 8 times on the membrane (i.e. the flow-through from Example 2) was recirculated again on the membrane for 1 hour (following storage for four days in a refrigerator) using a flow rate of 25 ml/min. The homogenate was then washed with equilibration buffer (25 mM Bis-Tris, pH 6.0/10 mM NaCl). Elution was performed using 3 M NaCl in 5 mM NH₄Ac/HAc, pH 5.5 (as previously).

The carbazole test gave 3.02 mg total in the eluate. The eluate was desalted and concentrated as described in Example 3.

### EXAMPLE 5

### Salmon Gills Extract

A salmon gill extract was made by homogenizing 444.4 g salmon gills (the gills were cut out, leaving the cartilage, gristle) in Milli-Q water. Proteins were degraded by papain at 55° C., then inactivated by heating to 80° C. Coarse particles were removed by filtering through a nylon filter. The pH in the homogenate was measured to 6.81, this was adjusted using 6 M HCl to 6.0.

The homogenate was centrifuged (12,000 rpm for 30 minutes). The supernatant was saved and, prior to each elution step was recirculated on the membrane for 60 minutes using a flow rate of 25 ml/min.

Elution 1: Washing and elution (Eluate no. 1) was carried out with 3 M NaCl/5 mM Bis-Tris, pH 6.0.

Elution 2: The membrane was treated with 1 M NaOH for 45 minutes before the next recirculation (of the flow-through from Elution 1), washing and elution were carried out as described above (Eluate no. 2).

Elution 3: The membrane was then treated with 1 M NaOH overnight, followed by recirculation of the flow-through from Elution 2, washing and elution as described above (Eluate no. 3).

The amount of uronic acid-containing glucosaminoglycan was determined using the carbazole test in triplicate for each eluate:

| Eluate | Weight of uronic acid-containing GAG (mg) |
|---|---|
| 1 | 8.6 |
| 2 | 6.2 |
| 3 | 5.6 |

The pooled extracts (eluates 1 to 3) were desalted, concentrated and freeze-dried (as described in Example 5). The weight of the freeze-dried sample was around 61 mg. The freeze-dried eluate was a white, fluffy powder. An activity test gave a total of 2.56 U in 61 mg.

The flow-through of the homogenate after eluates 1, 2, 3 was recirculated on the membrane 6-7 days after the first round (i.e. after elutions 1, 2 and 3).

Eluates 4, 5 and 6 were obtained as above. The membrane was treated with 1 M NaOH 45 minutes after eluate 5. The results are given in the following table:

| | Weight of uronic acid-containing GAG as measured by |
|---|---|
| Eluate | the carbazole test (mg) |
| 4 | 7.4 |
| 5 | 11.2 |
| 6 | 7.4 |

The pooled eluates (4 to 6) were desalted, concentrated and freeze-dried. The membrane was then equilibrated using 25 mM Bis-Tris/10 mM NaCl, pH 6.0 and the flow-through from Elution 6 was recirculated on the membrane for 1 hour using a flow rate of 25 ml/min and eluted using 3 M NaCl in 5 mM NH₄Ac/HAc, pH 5.5 (Eluate 7). The homogenate (i.e. the flow-through from Eluate 7) was then adjusted to pH 7.0 using 4 M NH₃. The membrane was equilibrated using NH₄Ac/HAc, pH 7.0. and the homogenate was recirculated on the membrane for 1 hour using a flow rate of 25 ml/min, then eluted as above (Eluate 8). The results of the carbazole test of Eluates 7 and 8 are shown below:

| | Weight of uronic acid-containing GAG as measured by |
|---|---|
| Eluate | the carbazole test (mg) |
| 7 | 5.6 |
| 8 | 6.4 |

### EXAMPLE 6

### Activity tests

The pool of intestine extracts (i.e. the combined eluates 1 to 7 from Example 1) was concentrated and desalted on Millipore Pellicon 0.5 m² 1000 MWCO-membrane (tangential flow), then freeze-dried. The resulting freeze dried sample has a weight of around 630 mg, an aliquot of 21.5 mg was submitted to activity testing at the Central Laboratory, Aker University Hospital, Norway.

Analysis showed a total activity of 0.26 U, i.e. 12 U/g and 7.6 U from the whole batch. The carbazole test gave 7.12 mg total which gives 1.07 U/mg.

Two pools of eluate from gill homogenate eluate (from Example 7), i.e. pool of eluates 1, 2, 3 and pool of eluates 4, 5, 6 were desalted and concentrated in an Amicon stirred cell w/1000 MWCO-filter.

Analysis showed Eluate 1, 2, 3 to have an activity of 0.21 U in 5.0 mg, i.e. 0.042 U/mg.

Total: 2.56 U in 61 mg, i.e. 0.042 U/mg (by weight).
After carbazole-test: 2.56 U in 20.4 mg (0.125 U/mg)

Analysis showed Eluate 4, 5, 6 to have an activity of 0.11 U in 2.4 mg.

Total: 1.12 U in 24.5 mg, i.e. 0.046 U/mg (by weight).
After carbazole-test: 1.12 U in 26 mg (0.043 U/mg).

The eluate from Example 6 (i.e. that from intestine homogenate of Example 3 and kept in fridge when not in use) was desalted and concentrated in Amicon stirred cell with 1000 MWCO, total weight: 0.269 g, aliquot to test: 0.020 g.

Result: 0.23 U/ml, i.e. 3.09 U total (0.0114 U/mg).

Eluates 7 and 8 from Example 5 and the flow-through from Eluate 8 were concentrated and desalted in Amicon stirred cell and gave a total weight of 0.091 g.

An aliquot of 0.0023 g was submitted for testing and gave 0.1 U/ml.

Total activity: 3.95 U, i.e. 0.0434 U/mg.

Fractionated eluate on Sephadex G75 (from Example 3)<8000, conc. and desalted in Amicon stirred cell gave a total weight of 0.161 g.

An aliquot of 0.0118 g gave 0.12 U/ml.
Total activity: 1.64 U, i.e. 0.010 U/mg.

>8000 pool from the Sephadex G 75 fractionation above was concentrated and desalted in Amicon stirred cell resulting in a total weight of 0.030 g. An aliquot of 0.0008 g gave 0.53 U/ml, i.e. 19.88 U total. This corresponds to 0.663 U/mg.

### EXAMPLE 7

### Recirculation Time and Speed

An extract from salmon intestines (498 g, stored at −20° C.) was made by homogenizing the salmon intestines in 498 ml Milli-Q water, using a Braun handheld homogenizer for a few minutes. Protein digestion was carried out at 55° C. for 3 hours, using 0.5 g papain, followed by inactivation at 80° C. for 1 hour.

After cooling to room temperature, the homogenate was filtered through a nylon filter, removing the course particles. The pH of the filtrate was adjusted to 6.2 using 0.5 M citrate buffer, pH 6.2. The final volume was 1000 ml which was divided into 5 aliquots of 200 ml and kept at +4° C. when not in use.

The membrane was treated with 1 M NaOH for 1 hour between every use. The equilibration buffer was 25 mM citrate buffer, pH 6.2/10 mM NaCl in all experiments described in this Example. In each case elution was performed using 25 mM citrate buffer, pH 6.2/10 mM NaCl.

After equilibration with the buffer, the homogenate was recirculated for the given period of time, then washed with ca. 100-120 ml of the equilibration buffer and eluted.

The amount of glycosaminoglycan (GAG) was determined by measuring the volume of the eluates and performing the carbazole test using 3-4 aliquots of 3 μl (12 μg) unfractionated porcine heparin for standard and 3-7 aliquots (200 μl) of the eluates.

Different aliquots of the homogenate was used for each experiment. The inlet and outlet of the homogenate was in the same beaker. The recirculation speed was 22 ml/min. The elution speed was 1.4 ml/min. The results are shown in the following table:

| | |
|---|---|
| Recirculation time | total amount of GAG (mg) |

| | | |
|---|---|---|
| 45 | minutes | 1.683 |
| 1 | hour | 2.860 |
| 2 | hours | 2.314 |
| 5 | hours | 1.935 |

In a further experiment the recirculation speed was 9.7 ml/min, using the Pharmacia P-1 pump and the last 200 ml aliquot of the homogenate. Recirculation was performed for 1 hour and elution speed was as above. The total amount of GAG detected was 1.843 mg.

### EXAMPLE 8

### Effect of Fines Removal and pH

The 5 aliquots used in Example 7 were pooled, mixed and divided into 5 equal aliquots. The contents of aliquot 1 were centrifuged at 12 000 rpm (23 975×g) for 30 minutes. The supernatant was pipetted off, taking care to avoid the lipid layer and the precipitate.

This supernatant was then recirculated (22 ml/min) on the Sartobind Anion Direct membrane for 1 hour. The membrane was equilibrated against 25 mM citrate buffer pH 6.2/10 mM NaCl. After recirculation, the membrane was washed with the equilibration buffer (110-120 ml) and eluted using 20 ml 3.5 M NaCl in 5 mM citrate buffer pH 6.2. The membrane was incubated with 1 M NaOH for 1 hour, then washed against the pH 6.2 equilibration buffer.

An aliquot (not centrifuged) was then allowed to recirculate on the membrane for 1 hour. Washing and elution was performed as above.

The volume and amount of GAG (carbazole-test) was determined:

| Sample | Amount GAG (mg) |
|---|---|
| Centrifuged homogenate | 4.173 |
| non-centrifuged homogenate | 4.377 |

This Example shows that untreated, crude homogenate from intestines can be applied onto the membrane adsorber in the process of the invention. In contrast, the homogenate from gills should ideally be centrifuged or otherwise subjected to fines-removal.

Thus, a further advantage of this method is that crude or fines-filtrated homogenate can be applied, while conventional anion chromatography requires a more extensive centrifugation or filtration.

The effect of pH was also investigated. The pH was checked in a 3rd homogenate-aliquot and found to be 6.73, in spite of the pH-adjustment in Example 9. The pH in this aliquot was adjusted to 5.5 using solid citric acid. The membrane was equilibrated with 25 mM citrate buffer pH 5.5/10 mM NaCl. The homogenate was recirculated (22 ml/min) for 1 hour, washed (110-120 ml) and eluted using 3.5 M NaCl/5 mM citrate buffer, pH 5.5.

Volume and amount of GAG (carbazole-test) was determined and compared in parallel to previous eluates from 1 hour recirculation (Example 7).

| Sample | amount GAG (mg) |
|---|---|
| Eluate pH 5.5 | 2.209* |
| Eluate pH 6.2 | 3.115 |
| Eluate pH 6.2 | 3.434* |

The pH 5.5-eluate appears to give a lower yield, however, it gave a purer product than the pH 6.2-eluates.

An aliquot of 0.0287 g of the pH 5.5 eluate above and an aliquot of 0.0571 g of the second pH 6.2 eluate of the above table was tested for anti factor Xa activity at Aker university hospital and gave a total of 1.8 U and 3.1 U, respectively. This gives the following specific activities:

### Eluate pH 5.5: 62.71 U/g

### Eluate pH 6.2: 54.29 U/g

which indicates an advantage in the use of pH 5.5 elution.

### EXAMPLE 9

### Recirculation Time and Increased Speed of Recirculation

The remaining two aliquots from Example 7 were used. The speed of recirculation was calibrated to 44 ml/min. The equilibration buffer was 25 mM citrate buffer, pH 6.2/10 mM NaCl, the elution buffer was 3.5 M NaCl in 5 mM citrate buffer, pH 6.2. The elution speed was 1.4 ml/min (as in Example 7). The pH of the two homogenates was adjusted to 6.2 using solid citric acid.

In the first experiment, recirculation was allowed for 1 hour, then washed with 110-120 ml equilibration buffer and finally eluted. In the second experiment, recirculation was allowed for 30 minutes, then treated as above.

The volume and GAG-content (carbazole-test, 4×200 μl samples of eluate and 4×3 μl of standard) was determined in the two eluates.

| Recirculation time | Amount GAG (mg) |
|---|---|
| 30 min | 1.854 |
| 60 min | 1.787 |

As the difference is probably within the error of the method, both recirculation times give similar yields. Taken together with previous results (Example 7), similar yield can be obtained if the recirculation time is reduced to 30 minutes from 60 minutes and the speed of recirculation increased from 22 ml/min to 44 ml/min.

### EXAMPLE 10

### Effect of Temperature and of pH-Elution

The remains of the salmon intestine homogenate from Example 7 were pooled and divided into 5 aliquots of 189 ml and kept at +4° C. until use. Aliquot no. 1 was taken out, the pH adjusted to pH 5.5 using solid citric acid. This was recirculated on the equilibrated (25 mM citrate buffer, pH 5.5/10 mM NaCl) Sartobind Direct Anion membrane for 1 hour at 25° C. and with a pump (MasterFlex I/P) speed of 22 ml/min. The membrane was washed with 110-120 ml of the equilibration buffer. Elution was performed using 3.5 M NaCl/5 mM citrate buffer, pH 5.5 (20 ml).

Aliquot no. 2 was taken out and the pH adjusted as above. The aliquot was kept in a water bath and the temperature on the membrane was measured to 34° C. during recirculation. Apart from the temperature, the experiment was performed as above.

Aliquot no. 3 was taken out and pH adjusted as above. The aliquot was kept in a water bath and the temperature on the membrane was measured to 41° C. Apart from the temperature, the experiment was performed as above.

Aliquot no. 4 was taken out and pH adjusted as above. Recirculation on the Sartobind membrane was carried out at 27° C. and the experiment performed as above.

Elution was performed using first 20 ml 50 mM citrate buffer, pH 2.8, followed by 20 ml 500 mM citrate buffer, pH 2.8, in separate eluates.

The GAG content was determined using the carbazole test. The precise volume of the eluates (ca. 20 ml each) were determined as set out in the following table.

| Eluate | total amount of GAG (mg) |
|---|---|
| pH 5.5/25° C. | 4.438 |
| pH 5.5/34° C. | 2.703 |
| pH 5.5/41° C. | 3.324 |
| 50 mM pH 2.8/27° C. | 0.611 |
| 500 mM pH 2.8/27° C. | 1.663 |
| Sum pH 2.8 eluates | 2.274 |

There does not appear to be an increase in the yield at higher temperature. Two eluates were submitted for activity testing and specific activity determination (eluates at pH 5.5 and pH 6.2).

### EXAMPLE 11

### Recirculation

The last aliquot from Example 10 was recirculated on the membrane by keeping the inlet and the outlet tubing in separate beakers. The complete contents of the outlet beaker was transferred to the inlet beaker once this was emptied. This was performed for 1 hour (effective time) at 27° C. at the speed of 22 ml/min. The membrane was calibrated with 25 mM citrate buffer, pH 5.5/10 mM NaCl. The pH of the aliquot was adjusted to 5.5 before its use.

Elution was performed using 3.5 M NaCl/5 mM citrate buffer, pH 5.5. This eluate was compared to the 25° C. sample from Example 10. All samples were tested in quadruple (200 μl from the eluates and 3 μl from the standard, as usual in these Examples, unless otherwise noted).

| Eluate | total amount of GAG (mg) |
|---|---|
| Inlet and outlet in different beakers | 1.654 |
| Inlet and outlet in same beaker | 1.725 |

The results are comparable and the method has the advantage that the inlet and outlet tubing may be kept in the same beaker. This avoids transferring the contents in order to allow recirculation.

### EXAMPLE 12

### Production of krill GAG

Equal amounts of krill tissue and buffer (5 mM NH₄CO₃/NH₃ in 0.1 M NaCl, pH 9.0) or Milli-Q water are homogenized in a tissue grinder (kitchen utility type, Braun). Typically, 300 g tissue in 300 ml buffer/water is used. The homogenate is incubated 55° C. with 0.3 g papain for 3 hours and then at 80° C. for 1 hour and centrifuged at 13000 rpm. The supernatant is applied onto a Dowex (2×8, anion exchanger), which is equilibrated in the buffer above and washed with the same buffer. Glycosaminoglycans are eluted using 4 M NaCl in the same buffer. This eluate is concentrated and desalted in a stirred cell (Amicon 8400) with a Nanomax-50 filter (MW cut-off=1000 Da). The concentrated and desalted eluate is freeze dried.

### EXAMPLE 13

### Krill and Chromatographic Matrix

A krill extract is made by homogenizing 400 g frozen krill in Milli-Q water. Proteins are degraded by papain at 55° C., then inactivated by heating to 80° C. Coarse particles are removed by filtering through a nylon filter. The pH in the homogenate is adjusted using 6 M HCl to 6.0. The homogenate is centrifuged (12,000 rpm for 30 minutes). The resulting extract is then recirculated (by immersing the inlet and outlet of the tubing in the same beaker) on a Sartobind® Anion Direct, Strong basic anion exchanger membrane at 25 ml/min for 60 minutes and then washed with 200 ml of equilibration buffer (25 mM acetate/acetic acid/10 mM NaCl, pH 5.5). Elution is then carried out using 20 ml 3 M NaCl in 5 mM NH₄Ac/HAc, pH 5.5. Further elutions are carried out as stated above. The amount of uronic acid-containing glycosaminoglycan is determined using the carbazole test.

### EXAMPLE 14

### Production of Porcine GAG

Pig intestines were collected fresh from slaughter and kept on ice. The intestines were emptied of their contents and washed in tap water. 444 g of washed intestines were added to 444 ml of Milli-Q water and homogenized. Proteins were degraded by using papain at 55° C. for 3 hours, then inactivated at 80° C. for 1 hour. Coarse particles were removed by filtering through a nylon filter. The extract was then added to 0.5 M ammonium acetate/acetic acid (pH 5.5) to 25 mM (final concentration of acetate) and NaCl (final concentration of 10 mM). The pH was adjusted to 5.50 by adding 50% (v/v) acetic acid.

Purification: The resulting extract was then recirculated (by immersing the inlet and outlet of the tubing in the same beaker) on a membrane at around 25 ml/min for 45 minutes and then washed with 150-200 ml of the equilibration buffer (25 mM acetate/acetic acid/10 mM NaCl, pH 5.5). Elution was then carried out using 20 ml 4 M NaCl in 5 mM NH₄Ac/HAc, pH 5.5. The total amount of glycosaminoglycan in the eluate was determined as 0.515 mg using the carbazole test. The eluate was desalted and concentrated in an Athicon stirred cell w/1000 MWCO-filter. The freeze-dried eluate was tested for heparin activity at the Clinical Chemistry Core Unit, Aker University Hospital using the Stachrom Heparin Diagnostica assay. This gave a total of 3.7 antifactor Xa units.

1. A process for the production of a glycosaminoglycan composition, said process comprising subjecting a homogenate of glycosaminoglycan-containing non-mammalian marine animal material to chromatography using a chromatographic matrix in the form of a membrane adsorber.

2. A process for the production of a glycosaminoglycan composition, said process comprising subjecting a homogenate of glycosaminoglycan-containing non-mammalian marine animal material to chromatography using a chromatographic matrix, wherein said homogenate is repeatedly applied to said matrix.

3. The process claimed in claim 1 or claim 2 wherein said non-mammalian marine animal material is krill material.

4. The process claimed in claim 1 or claim 2 wherein said non-mammalian marine animal material is salmon material.

5. A process for the production of a glycosaminoglycan composition, said process comprising subjecting a homogenate of glycosaminoglycan-containing mammalian intestines to chromatography using a chromatographic matrix in the form of a membrane adsorber.

6. A process for the production of a glycosaminoglycan composition, said process comprising subjecting a homogenate of glycosaminoglycan-containing mammalian intestines to chromatography using a chromatographic matrix, wherein said homogenate is repeatedly applied to said matrix.

7. The process as claimed in claim 5 or claim 6 wherein said mammalian intestines comprise porcine or bovine intestines.

8. The process as claimed in any one of claims 2 to 4, claim 6 or claim 7 wherein said matrix is in the form of a membrane adsorber.

9. The process claimed in any one of the preceding claims wherein said composition comprises an anticoagulant glycosaminoglycan.

10. The process claimed in any one of the preceding claims wherein said composition comprises heparin.

11. The process claimed in any one of the preceding claims wherein said chromatographic matrix is an anionic exchange membrane.

12. The process as claimed in any one of the preceding claims further comprising depolymerisation and/or fractionation.

13. A glycosaminoglycan composition obtained by the process of any one of the preceding claims.

14. Glycosaminoglycans, particularly anticoagulant glycosaminoglycan or glucosaminoglycans, especially preferably heparins, extracted from krill.

15. The use of the product of claim 13 or claim 14 in medicine.

16. The product of claim 13 or claim 14 for use in medicine.
